(19) United States
(12) Patent Application Publication
(10) Pub. No.: US 2005/0076678 A1
(43) Pub. Date: Apr. 14, 2005

(54) Method of manufacturing optical elements

(75) Inventors: Hiroyuki Sawada, Nagano (JP); Naoki Takai, Nagano (JP); Miyuki Sakurai, Nagano (JP); Shinichiro Hirota, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: HOYA CORPORATION

(21) Appl. No.: 10/923,885

(22) Filed: Aug. 24, 2004

(30) Foreign Application Priority Data
Aug. 25, 2003 (JP) 300064/2003

(51) Int. Cl. C03B 11/00

(52) U.S. Cl. 65/83

(57) ABSTRACT

A method of manufacturing optical elements in which a precision-processed pressing mold is used and the molding surface thereof is transferred to a heat-softened preformed molding material to form an optically functional surface. In the method, post processing for centering and edging are conducted following precision pressing to determine the center axis of an optical element and/or to form on the periphery of the optical element a portion for mounting on some other component. The preformed molding material has a weight within a range of 110 to 155% of a weight of the optical element when the optical element has a biconvex or convex meniscus shape. The preformed material has a weight within range of 180 to 240% of a weight of the optical element when the optical element has a biconcave or concave meniscus shape.

### TECHNICAL FIELD

The present invention relates to a method of manufacturing optical elements in which a precision-processed pressing mold is used and the molding surface thereof is transferred to a heat-softened molding material to form an optically functional surface. More particularly, the present invention relates to a method of manufacturing optical elements in which post processing for centering and edging are conducted following precision pressing to determine the center axis of an optical element and/or to form on the periphery of the optical element a portion for mounting on some other component.

### BACKGROUND ART

There are known methods of manufacturing optical elements by precision pressing in which a preformed molding material such as a glass preform is press molded while in a heat softened state to mold optical elements such as lenses. The optically functional surfaces of the optical elements obtained by precision pressing can be precision molded to a desired shape by press molding without requiring post-processing such as grinding or polishing. Thus, such methods are particularly useful from the viewpoint of permitting the precision molding of aspherical surfaces and optically functional surfaces having micropattems. Molded articles thus obtained can be centered and edged by a post processing (where the peripheral portion of a molded article is cut away to align the center axis relative to the outer diameter with the optical axis) to determine the center axis. In some cases, during such processing, a flat portion perpendicular to the center axis can be formed along the circumference of the lens, or a flat portion perpendicular to the center axis can be formed and a lens mount portion or part serving as a reference surface for a lens mount can be provided to obtain a lens product.

Japanese Unexamined Patent Publication (KOKAI) Heisei No. 11-100219 discloses the elimination or reduction of excess volume required for the conveyance of a glass material during press molding to reduce the steps required for post-processing. However, this method proposes only the elimination or reduction of excess volume of a material relating to conveyance, and does not consider the volume (or weight) required for the post processing such as centering and edging.

Since optical elements such as lenses must satisfy the optical performance requirements of a given application, they are designed by known lens design methods to enhance desired optical properties. On this basis, the lens diameter, lens thickness, spherical or aspherical surface equation specifying either convex or concave surfaces, are determined. To obtain a lens having desired optical properties, the use of a molding material having suitable optical constants is important in addition to lens design. Normally, the final lens shape is determined at first, and then, the shape, weight, and the like of the molding material for manufacturing the lens are decided.

Materials that have been preformed to a prescribed shape, such as preforms, can be employed as the molding material. Hereinafter, the term “material preformed to a prescribed shape” is also referred to as a “preform” in the present Specification. For example, a preform may be preformed into a substantial shape of sphere, a shape having biconvex curved surfaces, disklike shape, or columnar shape. Normally, the shape of the molding material is desirably close to the shape of the lens that is to be produced to facilitate press molding.

In methods of manufacturing lenses in which the post processing such as centering and edging are conducted after press molding, the peripheral portion of the molded product is removed as centering and edging is carried out. Thus, the weight (or volume) of the preform to be prepared must be greater than the weight (or volume) of the lens that is to be produced. However, the preform weight (volume) has conventionally been determined by trial and error alone. Thus, when the preform weight (volume) is unnecessarily large, not only material is wasted, but there are problems in that the burden required for centering and edging increases and waste material in the form of glass powder and the like increases the burden on the environment. Further, it was found that when the preform volume exceeds a prescribed range, the load tends to be unevenly applied during pressing, resulting in poor surface precision. Still further, when the preform volume (weight) is reduced excessively, the lens mount portion becomes insufficient, slight displacement of preform causes variation in thickness during pressing results in deficient optically functional surfaces, and the yield deteriorates.

Accordingly, it has become necessary to determine a preform of suitable weight (volume) with neither shortfall nor overage without repeated trial and error in press molding.

Glass preforms are made by selecting a glass material capable of producing a lens having desired optical properties (such as refractive index nd and Abbé number νd) and preforming the selected kind of glass material into a suitable shape. The kind of glass herein means the glass type which depends on the glass composition.

However, upper and lower limits exist for the weight of the glass that can be preformed as a glass preform. These upper and lower limits vary with the glass composition. Further, the weight of the glass also varies with the shape of the preform that is to be preformed.

For example, when the glass preform is prepared by hot forming and the weight of the glass exceeds a certain range, it becomes difficult to conduct suitable dripping (or flowing down) or preforming following dripping (or flowing down). In the hot-forming, glass melt is caused to drip, or flow down, into a receiving mold from a nozzle and cooled while in a suitably maintained state (for example, while being floated on a gas flow) to preform a sphere free of surface defects or a biconvex curved surface shape. There are also cases when striae appear in the preform that is obtained due to the composition or physical properties of the glass material employed. When such preforms are employed in press molding, it becomes difficult to obtain high-quality lenses.

Further, when glass preforms are hot formed, even when the quantity dripping (or flowing down) from the nozzle is kept to a minimum, various glass compositions and preform shapes impose lower limits on the weight in order to keep weight precision to within a certain range.

In recent years, lenses with higher refractive indexes have been required for use in image capturing optical devices such as digital cameras. As a result, attempts have been made to obtain preforms by hot forming glass materials with high refractive indexes. However, high refractive index glass materials have shown a strong wetting property against the nozzle when in the form of glass melt and exhibit low viscosity when melted. It has often proved more difficult to obtain desired preforms of desired weight (volume) from such glass materials than from the glass materials that have conventionally been employed.

Normally, when attempting to obtain lenses having desired optical properties, a glass material having suitable optical constants from the perspective of lens design is decided upon, and based on the optical constants of the glass material, the lens shape is designed by known lens design methods. The volume of the lens that is designed can be calculated by lens design software, and the weight of glass of that volume can be calculated from the specific gravity of the glass material. The necessary weight of the preform can be calculated by adding the weight (volume) (assuming this can be accurately estimated) that is cut away by post processing for centering and edging to the weight (volume) of the lens to be obtained.

As stated above, there exist upper and lower limits to the weight of the glass that can be preformed as a preform by hot forming. Accordingly, when the calculated preform weight is outside the range of the weight of the glass that can be preformed as a glass preform, the particular lens cannot be molded. In such cases, a lens affording equivalent optical properties must be designed anew or modifications must be made. This is extremely troublesome.

Accordingly, the first object of the present invention is to provide a method of efficiently manufacturing optical elements from a preformed molding material by means of the steps of press molding, post processing for centering and edging, in which the weight of the molding material is determined within a range in which the amount being removed for centering and edging is minimized and problems such as inadequacy of the optically functional surface due to slight displacement of the material in press molding and the like, as well as poor surface precision, do not occur.

The second object of the present invention is to provide a method of efficiently manufacturing optical elements in which, in the course of press molding, a preform of suitable weight (volume) with neither shortfall nor overage is determined without repeated press molding or trial and error in lens design.

### SUMMARY OF THE INVENTION

The present invention relates to a method of manufacturing an optical element of prescribed shape, comprising the steps of; press molding a preformed molding material in a heat-softened state to obtain a press-molded product, and subjecting the press-molded product to a post processing for centering and edging, said preformed molding material having a weight within a range of 110 to 155% of a weight of the optical element when the optical element has a biconvex or convex meniscus shape, and said preformed material having a weight within range of 180 to 240% of a weight of the optical element when the optical element has a biconcave or concave meniscus shape (Hereinafter referred to Method 1).

In the above method, it is preferred that

(i) the preformed molding material is obtained by dropping or flowing glass melt from a nozzle and cooling;

(ii) the preformed molding material has a refractive index n_{d} of at least 1.7;

(iii) the preformed molding material comprises a phosphate glass;

(iv) the preformed molding material has a weight in a range of from 10 to 8,000 mg;

(v) the preformed molding material is substantially in a shape of sphere and has a weight in a range of from 10 to 1,000 mg; and

(vi) the preformed molding material has a biconvex curved surface shape and a weight in a range of from 150 to 8,000 mg.

The present invention further relates to a method of manufacturing an optical element comprising the steps of;

preparing a preformed molding material by dropping or flowing glass melt from a nozzle and cooling,

press molding the preformed molding material in a heat-softened state to obtain a press-molded product, and

subjecting the press-molded product to a post processing for centering and edging to obtain an optical element of biconvex shape or convex meniscus shape,

wherein the shape of the optical element is determined by a process comprising

(1) determining a type of glass based on optical properties of the optical element,

(2) determining a weight range or volume range of the molding material capable of being preformed based on the type of the glass, and

(3) determining the shape of the optical element so that a weight or volume of the optical element falls within a range of from 100/110 to 100/155 of the a weight or volume within said weight range or volume range of the molding material (Hereinafter referred to Method 2).

The present invention still further relates to a method of manufacturing an optical element comprising the steps of;

preparing a preformed molding material by dropping or flowing glass melt from a nozzle and cooling,

press molding the preformed molding material in a heat-softened state to obtain a press-molded product, and

subjecting the press-molded product to a post processing for centering and edging to obtain an optical element of biconcave shape or concave meniscus shape,

wherein the shape of the optical element is determined by a process comprising

(1) determining a type of glass based on optical properties of the optical element,

(2) determining a weight range or volume range of the molding material capable of being preformed based on the type of the glass, and

(3) determining the shape of the optical element so that a weight or volume of the optical element falls within a range of from 100/180 to 100/240 of a weight or volume within said weight range or volume range of the molding material (Hereinafter referred to Method 3).

### BRIEF DESCRIPTION OF THE DRAWINGS

FIG. 1 is a schematic view of a press molded article comprising a portion that is removed by post processing for centering and edging when manufacturing a biconvex lens.

FIG. 2 is a schematic view of the chamfered portion of a pressing mold that can be employed in the manufacturing method of the present invention.

FIG. 3 is a schematic view of a press molded article comprising a portion that is removed by post processing for centering and edging when manufacturing a concave meniscus lens.

Method 1 of the present invention permits press molding using a preform that is neither too much nor too little in weight (volume) and that is capable of being preformed. Since press molding can be conducted without providing the portion removed by centering and edging in excess amount, the burden required for such removing process following press molding can be reduced. Further, since press molding is conducted using a preform of a weight (or volume) that does not produce an inadequate optically functional surface due to uneven pressing, and a suitable load can be applied over the entire area of the optically functional surface to mold the lens, yielding a high-quality lens of high surface precision.

In Methods 2 and 3 of the present invention, since lens (optical element) design is conducted in consideration of the limits of molding materials employed in press molding, a preform of suitable weight (or volume) with neither too much nor too little can be determined without repeated trial and error in press molding and lens design. Thus lens production with high productivity is accomplished.

### BEST MODE OF IMPLEMENTING THE INVENTION

The present invention relates to a method of manufacturing an optical element comprising the step of press molding a preformed molding material in a heat-softened state and the step of post processing for centering and edging the press-molded product thus obtained to obtain an optical element of prescribed shape.

The manufacturing method of the present invention is characterized in that when the optical element to be obtained has a biconvex or convex meniscus shape, a molding material is employed that has a weight (or volume) within a range of 110 to 155%, desirably 110 to 140 % of the weight (or volume) of the optical element of prescribed shape that is to be obtained by the post processing. Preferred are 110 to 135% for a biconvex shape and 115 to 140% for a convex meniscus shape,

When the weight (or volume) of the preformed molding material is less than 110% of the weight (or volume) of the optical element to be obtained by post processing, the lens mount portion cannot be adequately fashioned, a slight unevenness in pressing results in short of optically functional surface, and a suitable load cannot be applied over the entire area of the optically functional surface to mold a lens, resulting in the problem of lowered surface precision. When the weight (or volume) of the preformed molding material exceeds 155% of the weight (or volume) of the optical element to be obtained by post processing, there are problems in that material is wasted, the workload required for post processing increases, and production efficiency decreases. Further, an unbalanced pressing load tends to be applied to the preform and surface precision is sometimes poor. Still further, there is a problem in that a burden is placed on the environment in the form of waste products of glass powder and the like.

In the manufacturing method (Method 1) of the present invention, a preform of weight (or volume) that is neither too much nor too little is employed in press molding with suitable load distribution to form an optically functional surface. Thus, the optically functional surface that is molded is of high surface precision even when not processed by polishing or the like. Thus, the manufacturing method of the present invention is suited to precision press-molding methods in which a precision processed pressing mold is employed, the molding surface thereof is transferred to a heat-softened molding material and an optically functional surface is formed.

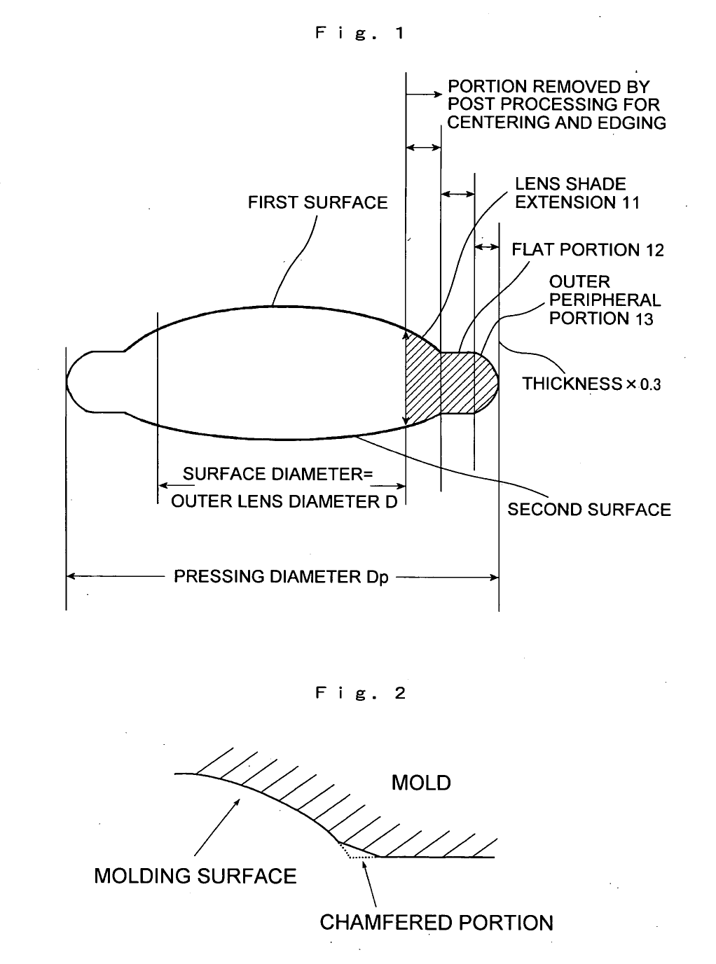

Since polishing is unnecessary when producing an optical element by precision press molding by the present invention, no consideration of the glass weight (or volume) removed by polishing is required. Accordingly, it suffices to consider the portion removed by the post processing for centering and edging and to conduct press molding so that the weight (or volume) of that portion falls within a range of from 10 to 55% of the weight (or volume) of the final product (optical element following centering and edging). This point will be described based on FIG. 1. FIG. 1 is a schematic view of a press-molded article including the portion that is removed by centering and edging when manufacturing a biconvex lens.

For example, when manufacturing a lens that is biconvex in shape such as is shown in FIG. 1, the shape and weight (or volume) of the portion that is removed by centering and edging can be determined in the following manner. (In FIG. 1, the hatched portion denotes the portion removed by centering and edging.)

The shape of the optically effective lens diameter and the final outer lens diameter are determined based on the application and the optical system in which the lens will be used to achieve the required optical performance of the lens and adequate mounting precision on the device. A portion of lens shape extension 11 of approximately constant width regardless of the lens diameter can be provided on the outside of the effective diameter. The shape of lens shape extension 11 is defined by a line extending, or substantially extending, the curve (or straight line) defining the shape of the first or second optically functional surface. The lens shape extension is necessary for an adequate and nearly uniform load to be applied over the entire area of the optically functional surface during press molding. Regardless of the lens shape and outer diameter, the width of the lens shape extension ranges from 0.2 to 0.4 mm which is the minimum necessary width and is desirable. A width of from 0.25 to 0.35 mm is preferred. Here, the term “width” means the width on a surface projected onto a plane orthogonal with the center axis (identical below).

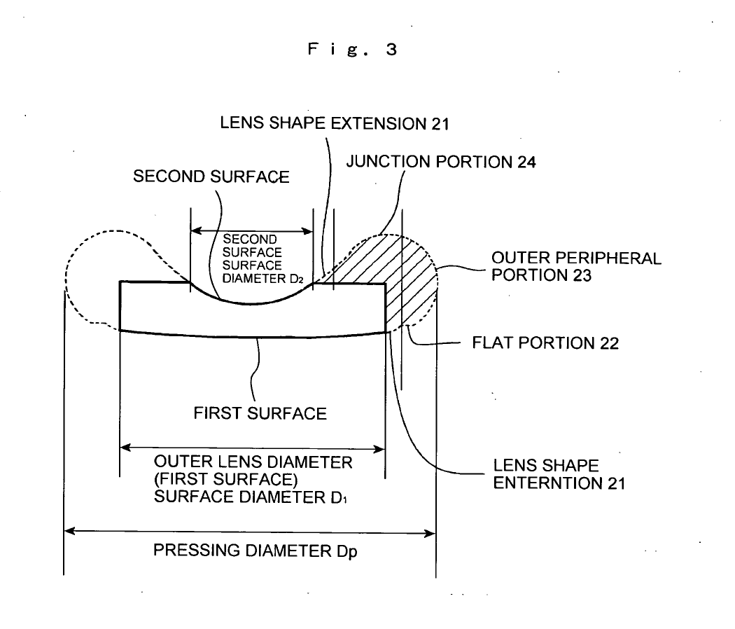

As shown in FIG. 2, a chamfered portion is desirably provided on the pressing mold to prevent damage to angular portions of the pressing mold in the present invention. FIG. 2 is a schematic view of a portion of a pressing mold that can be employed in the manufacturing method of the present invention. The cutting off of the corner can be done by a known method. However, when the portion adjacent to the chamfered portion during press molding is incorporated into the lens following post processing for centering and edging, the portion sometimes makes the thickness of the portion greater and may impede mounting of the lens. By contrast, when the above-described lens shape extension is provided and press molding is conducted so that the portion adjacent to the fixing portion of the pressing mold is incorporated into the lens shape extension, this problem can be avoided.

A flat portion 12 of a certain width is desirably provided at the periphery of lens shape extension 11. Flat portion 12 is a approximately perpendicular flat surface or gently curving surface relative to the center axis of the lens for achieving a smooth transition from above-described lens shape extension 11 to an outer peripheral portion 13, described further below. When a flat portion 12 is provided as a smooth transfer surface at this position, the lens following molding (before centering and edging) can be viewed to confirm the position of the ring shape by means of flat portion 12. In this manner, a lens made from eccentrically-located molding material can be readily discovered and removed as a defective product before post processing for centering and edging, thus avoiding unnecessary processing. Flat portion 12 may be provided on the first surface, on the second surface, or on both. Irrespective of the shape and outer diameter of the lens to be obtained, a range of from 0.2 to 0.4 mm is the minimum necessary width of the flat portion and is desirable. A preferred range is from 0.25 to 0.35 mm. This is a suitable width for readily and visually confirming the position of the ring shape relative to the outer lens diameter.

An outer peripheral portion 13 can be provided to the outside of lens shape extension 11 when there is no flat portion 12 and to the outside of flat portion 12 when flat portion 12 is present. Outer peripheral portion 13 is a portion that defines the pressing diameter of the lens and includes a free surface solidified without contacting the pressing mold during press molding. This portion can be of a width necessary for connecting both flat portions 12 (or lens shape extensions 11 when flat portions 12 are not provided) on the first and second surface sides. This width correlates with the thickness of the lens in that portion, and is 0.25 to 0.35-fold, preferably 0.28 to 0.32-fold, the thickness thereof.

The shape of lens shape extension 11, flat portion 12, and outer peripheral portion 13 after molding (before post processing for centering and edging) can be determined in this manner. The volume of lens shape extension 11, flat portion 12, and outer peripheral portion 13 can be calculated by plotting the cross-sectional shapes thereof on coordinate axes and calculating the volumes of the bodies of rotation.

The volume of the lens following post processing for centering and edging, that is, the volume of the desired lens, can be calculated from its shape. Specifically, it can be calculated by the method set forth above or by lens design software. The total of the volumes (or weights) of the lens shape extension, flat portion, and outer peripheral portion that are calculated can be added to the volume (or weight) of the lens to be obtained to calculate the volume (or weight) of the molded article prior to centering and edging. The volume (or weight) before and after centering and edging can be computed in this manner. As stated above, when conducting precision press molding by the present invention, press molding is conducted so that the weight (or volume) of the portion that is removed by centering and edging falls within a range of from 10 to 55% of the weight (or volume) of the optical element following centering and edging.

The manufacturing method of the present invention is characterized in that, when the optical element to be obtained has a biconcave or concave meniscus shape, the molding material employed has a weight (or volume) falling within a range of from 180 to 240% of the weight (or volume) of the optical element of prescribed shape that is to be obtained by post processing for centering and edging. This range is from 200 to 235% in the case of a concave meniscus shape.

When the weight (or volume) of the preformed molding material is less than 180% of the weight (or volume) of the optical element that is to be obtained by post processing for centering and edging, there are problems in that the lens mount portion cannot be adequately fashioned, the optically functional surface is rendered insufficient by eccentrically-located material during pressing, and the lens cannot be molded by applying a suitable load over the entire area of the optically functional surface, compromising surface precision. Further, when the weight (or volume) of the preformed molding material exceeds 240% of the weight (or volume) of the optical element to be obtained by centering and edging, there are problems in that material is wasted, the workload required for centering and edging increases, and production efficiency deteriorates. There are also cases when an unbalanced pressing load is applied to the preform, resulting in poor surface precision. Still further, there is a problem in that waste material in the form of glass powder and the like increases the burden on the environment.

As stated above, the manufacturing method of the present invention is suited to obtaining optical elements by precision press molding. In the present invention, since polishing of the molded surfaces is unnecessary when obtaining optical elements having biconcave or concave meniscus shapes by precision press molding, there is no need to consider the weight (or volume) of the glass removed by polishing. Accordingly, it suffices to consider the portion removed by centering and edging and conduct press molding so that the weight (or volume) of that portion falls within a range of from 80 to 140% of the weight (or volume) of the final product (optical element following centering and edging). This point will be described based on FIG. 3 below. FIG. 3 is a schematic view of a press-molded article including the portion that is removed by centering and edging when manufacturing a concave meniscus lens.

For example, when manufacturing the lens of concave meniscus shape shown in FIG. 3, the weight (or volume) of the portion removed by post processing for centering and edging is taken into account so that it falls within a range of from 80 to 140% of the weight (or volume) of the final product, and the shape of that portion can be determined in the following manner. (In FIG. 3, the hatched portion denotes the portion removed by centering and edging.)

In FIG. 3 (a vertical cross-sectional view of the lens), a portion of lens shape extension 21 is provided to the outside of the surface diameter D2 on the second surface (concave surface) side. This width can be from 0.2 to 0.4 mm, for example. The shape of lens shape extension 21 is desirably determined so that a load can be properly applied to optically functional surfaces of the second surface and so that a suitable connection can be formed with the junction portion, described further below. This portion is defined by a line extending, or substantially extending, the curve (or straight line) specifying the optically functional surface shape of the second surface. Further, the shape of this portion desirably has a point of inflection on the outer circumference (point of contact with the junction portion) thereof, becoming a curved surface of reverse curvature from the optically functional surfaces of the second surface.

The lens shape extension on the first surface side is defined by a line that extends, or substantially extends, the curve (or straight line) defining the optically functional surface of the first surface. This portion is necessary so that an adequate load is applied over the entire optically functional surface during press molding, and is desirably from 0.2 to 0.4 mm, irrespective of lens shape and diameter. Preferred is a range of from 0.25 to 0.35 mm.

Junction portion 24 can be provided to the outside of lens shape extension 21 of the second surface. This portion is a portion connecting with an outer peripheral portion 23 provided to the outside thereof. Junction portion 24 extends with prescribed curvature, with the tangent being nearly horizontal beyond the surface diameter D1 (desirably over a width of 0.2 to 0.4 mm beyond the position of D1) of the first surface and desirably connecting with the outer peripheral portion 23. The volume of the preform can be adjusted by controlling the shape of junction portion 24. However, when the volume of junction portion 24 is excessively small, the curve on the side of the pressing mold transferring its surface becomes steep and surface processing of the mold becomes difficult. Conversely, when this portion is made excessively large, the volume of the preform increases, making it difficult to apply a suitable load over the entire effective diameter in the pressing step and making it difficult to achieve high surface precision. The radius of curvature of the junction portion is preferably from 0.5 to 10 mm, more preferably from 3 to 7 mm.

An outer peripheral portion 23 can be provided to the outside of junction portion 24. Outer peripheral portion 23 is a portion determining the pressing diameter of the lens, part or nearly all of which becomes free surface depending on the structure of the pressing mold. The width of outer peripheral portion 23 is preferably made 0.25 to 0.35-fold, more preferably 0.28 to 0.32-fold, the thickness of the portion adjacent to the junction portion.

In the case of the lens of concave meniscus shape shown in FIG. 3, the forming of the flat portion described above is also useful. FIG. 3 shows the case where a flat portion 22 is provided on the first surface side. The width of this portion is preferably from 0.25 to 0.35 mm, as was the case for the above-described biconvex lens.

In the manufacturing method of the present invention, hot forming is desirably employed; that is, a prescribed quantity of glass melt (glass heated to elevated temperature to achieve a suitable viscosity, or glass the temperature of which is adjusted to suitable viscosity from a molten state) is made to drip or flow from a nozzle and cooled while being maintained in a suitable state to preform a molding material.

In precision press molding, the surface of the preform is often deformed into part of the surface of the optical element that is the final product. Thus, any processing traces run the risk of becoming defects in the vicinity of the surface of the optical element. However, since hot forming produces preforms without defects in the vicinity of the surface, high-quality optical elements can be provided by precision press molding with good production efficiency. In particular, the present invention is capable of yielding molding materials comprised of free surfaces that have been formed by solidifying the entire surface of a piece of glass melt by floating on a gas flow a piece of glass melt that has dripped or flowed down from a nozzle, and then cooled the piece in a state of essentially non-contact with the floating jig. Further, during cooling, it is desirable for the glass melt to be solidified at a selected cooling rate while being floated on a gas flow. This yields glass preforms free of surface defects.

This hot molding makes it possible to preform high-quality glass preforms from a variety of optical glasses. However, the difficulty of preforming varies with the type of glass. For example, depending on composition, there are types of glass having low viscosity at high temperature and types of glass tending to wet the nozzle during the dripping of glass melt. For types of glass having low viscosity at high temperature and types of glass tending to wet the nozzle during the dripping of glass melt, the weight range over which preforming is possible with good weight precision tends to be narrow. In cases where optical elements are produced via post processing for centering and edging, the weight precision of the preforms desirably does not exceed±2%.

As stated above, there are upper and lower limits to the weight (or volume) of preforms that can be preformed by hot forming due to the type of glass and the shape of the molding material to be obtained. Accordingly, in the manufacturing method of the present invention, the type of glass employed is determined based on the optical properties of the optical elements to be obtained. For a given type of glass, the weight (or volume) range of preforms that can be preformed by hot forming is calculated and the weight (or volume) of a preform is desirably determined to fall within that range.

The range of the weight (or volume) of the preforms that can be preformed by hot forming can be estimated from the liquid phase temperature of the glass and the viscosity of the glass at that temperature. However, depending on the type of glass, striae are sometimes produced within the weight (or volume) range estimated based on liquid phase temperature and viscosity. Thus, it is desirable to determine strict upper and lower values by actual molding.

The manufacturing method of the present invention is effective for obtaining optical elements with high refractive indexes. The molding material employed in the manufacturing method of the present invention desirably has a refractive index (nd) of greater than or equal to 1.7. However, glasses having a refractive index (nd) of greater than or equal to 1.7 contain a relatively high level of high refractive index components (for example, Ti, W, Nb, and Zr), which tend to lower the viscosity of the glass melt. Further, striae tend to occur during hot molding. Still further, the stability of the glass is low and the region in which hot forming is possible is narrow. When employing a glass material having a refractive index (nd) of greater than or equal to 1.7 in the manufacturing method of the present invention, striae do not appear and preforming can be conducted with good weight precision when the weight of the preform falls within a range of from 10 to 8,000 mg, preferably from 100 to 8,000 mg. Further, when employing a molding material with a refractive index (nd) of greater than or equal to 1.8, preforming can be conducted with good weight precision when the weight of the preform falls within a range of from 100 to 7,000 mg. The weight range over which preforming is possible is affected by the shape of the molding material; relative to sphere shaped glass preforms, ranges over which forming of glass preforms having biconvex curved surface shapes is possible tend to shift to large side. Sphere shaped glass preforms desirably have a weight range of from 10 to 1,000 mg, and glass preforms having biconvex curved surface shapes have a weight range of from 50 to 10,000 mg, preferably a weight range of from 100 to 8,000 mg.

The molding material of the manufacturing method of the present invention can be comprised of phosphate glass (here referring to glass the major network component of which is phosphoric acid; identical below). Phosphate glass tends to wet the nozzle during the dripping of glass melt. Thus, the preforming of molding material by hot forming is often more difficult than with glasses such as borate glass, silicate glass, and borosilicate glass. When employing a molding material comprised of phosphate glass, a preform having a weight falling within a range of 100 to 8,000 mg can be preformed with weight precision. When employing phosphate glass, sphere shaped glass preforms desirably have a weight ranging from 100 to 1,000 mg and glass preforms that have a biconvex curved surface shape desirably have a weight ranging from 150 to 8,000 mg. When employing phosphate glass having a high refractive index nd of greater than or equal to 1.7, the weight desirably ranges from 100 to 4,000 mg.

In the manufacturing method of the present invention, a molding material comprised of borate glass, silicate glass, or borosilicate glass may be employed. When employing borate glass, silicate glass, or borosilicate glass, the weight of the preform can range from 10 to 10,000 mg. In this case, sphere shaped glass preforms desirably have a weight ranging from 10 to 1,000 mg and glass preforms having a biconvex curved surface shape desirably have a weight ranging from 50 to 10,000 mg to enhance weight precision.

When using optical glass with a specific gravity of greater than or equal to 4.0 as molding material in the manufacturing method of the present invention, preforms having a weight ranging from 50 to 8,000 mg, preferably ranging from 100 to 7,000 mg is desirable because they permit the manufacturing with good weight precision.

The upper and lower weight values of the molding material that can be preformed are changing with progress in preform molding techniques and the degree of freedom may broaden. Further, as stated above, when determining the shape of the molding material, it is important to remember that the range in which preforming is possible varies with the shape of the glass preform. That is, the range in which molding of glass preforms having a biconvex curved surface shape is possible tends to be on the heavy side relative to that of spherical glass preforms. Thus, for example, when employing glass preforms of 1,000 mg or above, a biconvex curved surface shape is desirably selected.

In the manufacturing method of the present invention, the step of press molding a preformed molding material while in a heat softened state can be conducted by known methods. Further, in the present invention, it is preferred that the shape of the portion removed by post processing for centering and edging is determined in advance by employing a method such as that set forth above, a pressing mold corresponding to that shape is manufactured, and the resultant pressing mold is employed to conduct press molding.

The step of centering and edging a press molded article to obtain an optical element may also be conducted by known methods in the manufacturing method of the present invention. The post processing for centering and edging step can be minimized in the present invention. Specifically, the machining allowance (amount of grinding) in centering and edging can be reduced to shorten the centering and edging processing time. That is, a press molded article having the minimum machining allowance that does not result in a press molded article of inadequate weight (or volume) and that does not produce a lens with an inadequate optically functioning surface due to uneven thickness can be manufactured by the manufacturing method of the present invention.

The present invention also relates to the following method:

a method of manufacturing an optical element comprising the steps of;

preparing a preformed molding material by dropping or flowing glass melt from a nozzle and cooling,

press molding the preformed molding material in a heat-softened state to obtain a press-molded product, and

subjecting the press-molded product to a post processing for centering and edging to obtain an optical element of biconvex shape or convex meniscus shape,

wherein the shape of the optical element is determined by a process comprising

(1) determining a type of glass based on optical properties of the optical element,

(2) determining a weight range or volume range of the molding material capable of being preformed based on the type of the glass, and

(3) determining the shape of the optical element so that a weight or volume of the optical element falls within a range of from 100/1 10 to 100/155 of the a weight or volume within said weight range or volume range of the molding material.

The present invention also relates to the following method:

a method of manufacturing an optical element comprising the steps of;

preparing a preformed molding material by dropping or flowing glass melt from a nozzle and cooling,

press molding the preformed molding material in a heat-softened state to obtain a press-molded product, and

subjecting the press-molded product to a post processing for centering and edging to obtain an optical element of biconcave shape or concave meniscus shape,

wherein the shape of the optical element is determined by a process comprising

(1) determining a type of glass based on optical properties of the optical element,

(2)determining a weight range or volume range of the molding material capable of being preformed based on the type of the glass, and

(3) determining the shape of the optical element so that a weight or volume of the optical element falls within a range of from 100/180 to 100/240 of a weight or volume within said weight range or volume range of the molding material.

A more specific method will be described for the example of a glass lens.

A Biconvex Lens or Convex Meniscus Lens

In the course of manufacturing a biconvex lens or convex meniscus lens, the type of glass employed is determined based on the optical properties of the lens to be obtained.

Usually, a suitable type of optical glass is selected from among the various optical glasses to obtain a lens with desired optical properties. The selection criteria are primarily the optical constants (refractive index, dispersion), but chemical and mechanical durability, coloration, and the like may also be considered. Often, the selection can be made based on the specifications of the optical device in which the lens is to be applied.

Once the type of glass has been determined, the range of weight (or volume) of molding materials that can be preformed for that type of glass is calculated. As stated above, the range of weight (or volume) of molding materials that can be preformed can be estimated from the liquid phase temperature and viscosity of the glass. However, striae are sometimes generated within the weight (or volume) range estimated based on the liquid phase temperature and viscosity, depending on the glass. Thus, a strict upper limit and lower limit are desirably determined by actual molding. Since the range of the weight (or volume) of the preformed molding material varies with the shape of the preformed molding material (for example, a glass preform), the range of the weight (or volume) and the shape of the preformed molding material are desirably both determined. It is desirable that the range of the weight (or volume) of the preformed molding material is predetermined by type of optical glass and preform shape, and that these data are retained.

There are cases where the shape of the preform is limited by the shape of the lens to be obtained. For example, when the curvature of the convex surface of a lens to be obtained is greater (the radius of curvature is smaller) than the curvature of the convex surface of the preform, there is a risk that gas trapped between the preform and the molding surface will not be discharged and will deform the lens shape during press molding. Accordingly, a preform shape is desirably selected so that a preform convex surface curvature is greater than the curvature of the convex surface of the lens. In such cases, the selection of a spherical preform is desirable. However, as stated above, the preforming of large preforms is easier for oblong sphere shapes with biconvex curved surfaces than for sphere shapes; this point is also desirably considered. Thus, before making a final determination of the shape of the lens to be obtained, it is desirable to consider the capability of obtaining the preform and comprehend the overall lens shape.

Once the weight (or volume) range of preformable molding materials has been calculated for a given type of glass, the lens shape is determined so that the weight (or volume) of the lens to be obtained falls within a range of from 100/110 to 100/155, desirably a range of 100/110 to 100/140, of the weight (or volume) within the weight (or volume) range of the preformable molding materials.

Post processing for centering and edging can be minimized by determining a preform weight (or volume) falling within a range within which preforming is possible by hot forming based on the above operation. Further, the shape of a lens having the desired optical properties can be determined in the range in which the problem of a shortage of optically functioning surface due to eccentrically located material does not occur.

In practice, the weight (or volume) range of the preformable molding material is converted to a volume range based on the specific gravity of that particular type of optical glass, the shape of a lens having desired optical properties is designed so that the volume of the lens to be finally obtained falls within a range of from 100/1 10 to 100/155 within that volume range, and the final lens shape can be determined. Determination of the lens shape includes determination of the shapes of the first and second optically functional surfaces. This can be done by known lens design methods based on the optical constants of the materials employed and the desired optical properties.

The shape of the molding surface of the pressing mold used to mold the first and second surfaces of the optical element is determined based on the shape of the optically functional surface that is determined, a pressing mold having molding surfaces of the determined shapes is prepared, the pressing mold is employed to press mold the molding material while in a heat-softened state, and the molded article obtained can be subjected to the post processing for centering and edging to obtain a desired optical element.

Biconcave Lenses and Concave Meniscus Lenses

In concave lens systems (biconcave or meniscus), the weight (or volume) of the lens to be obtained is desirably selected from a weight (or volume) of 100/180 to 100/240, and particularly for a concave meniscus shape, 100/200 to 100/235,within the weight (or volume) range of the preform, the remainder being identical to what has been set forth above.

When the optical element being obtained by the manufacturing method of the present invention is a lens (including biconvex lenses, convex meniscus lenses, biconcave lenses, and concave meniscus lenses), the effective diameter of the lens is desirably about 2 to 28 mm. When the effective diameter of the lens lies within this range, a lens having high surface precision can be obtained by precision press molding. Within this range, the effect of the present invention is marked.

The lens obtained by the present invention may be either a spherical lens or an aspherical lens, and it is desirable that the lens has at least one aspherical surface.

The application of the lenses obtained by the manufacturing method of the present invention is not specifically limited. The lenses that can be obtained by the manufacturing method of the present invention are suitably employed as the biconvex lenses, convex meniscus lenses, and concave meniscus lenses used in the image capturing optical devices such as cameras (including digital and VTR cameras).

Glass materials have been given as examples of molding materials and glass lenses as examples of optical elements above. However, the present invention is not limited thereto.

### EMBODIMENTS

The present invention will be described specifically below through embodiments. However, the present invention is not limited to these embodiments.

### Embodiment 1

Manufacturing Biconvex Lenses

A biconvex shape was adopted as the final shape of a lens obtained by centering and edging a press-molded article. The biconvex lens comprised of glass E shown in Table 3 was press molded by the procedure given below.

First, the lens was designed by a known lens design method based on the optical constants of the glass material. Next, the volume of the biconvex lens was calculated with lens design software, and from the specific gravity of the glass material employed, the weight of the glass corresponding to that volume, that is, the weight of the biconvex lens to be obtained, was calculated as 550 mg.

Next, denoting the calculated weight of the biconvex lens as 100, multiple (seven types) of biconvex curved surface glass preforms for obtaining this biconvex lens were formed by hot forming with weights of 105, 110, 126, 140, 155, 162, and 175, respectively.

Next, while in a heat-softened state, each of the glass preforms was pressed at a prescribed load in a mold for molding convex lenses to form a press-molded article. As shown in FIG. 1, the approximate shape of the press-molded article had a center portion (of lens outer diameter D) that would become the final product, and moving outward, a lens-shaped extension 11, a flat portion 12, and an outer peripheral portion 13. The weights of each of these portions varied. With the exception of the weights of the glass preforms, the molding conditions were identical.

Next, each of the press-molded articles was annealed at a temperature not exceeding the glass transition temperature Tg thereof to relieve internal stress and adjust the refractive index of the press-molded articles.

Each of the press-molded articles was then subjected to the post processing for centering and edging, the outer peripheral portion of the molded article was cut away, and the center axis relative to the outer diameter was determined. In post processing for centering and edging, the lens was held with a bell clamp and the lens circumference edge surface was processed to achieve the lens shape. Not more than 20 seconds per lens was allowed for centering and edging. The seven biconvex lenses obtained were evaluated for external appearance, performance, and time required for centering and edging. The evaluation results are given in Table 1.

TABLE 1

| | Weight ratio | | | | | | |
|---|---|---|---|---|---|---|---|
| Evaluation | 105 | 110 | 126 | 140 | 155 | 162 | 175 |
| External appearance | B | A | A | A | A | A | A |
| Performance | B | A | A | A | A | B | B |
| Time required for | A | A | A | A | A | B | B |
| post processing for | | | | | | | |
| centering and edging | | | | | | | |

In Table 1, lenses with a defect rate of less than 10% are denoted by “A” and those of 10% or more by for external appearance and performance. Lenses falling within the permitted range obtained by conversion of manufacturing cost are denoted by “A” and those exceeding the permitted range by “B” for the time required for post processing for centering and edging.

As will be seen from Table 1, the biconvex lenses obtained from preforms with a weight ratio of 105 had insufficient volume and did not yield the desired shape, achieving external appearance and performance evaluations of “B”.

The biconvex lenses obtained from preforms having weight ratios of from 110 to 155 presented no problem in either evaluation category, with failure rates of less than 10%. However, the biconvex lenses obtained from weight ratios of 162 and 175 were due to slight eccentrically located materials, presenting astigmatism and eccentricity defects. Further, the time required for post processing for centering and edging exceeded the allowed range. Thus, the performance and post processing for centering and edging time evaluations were “B”.

Based on the above inspection, when the weight of the final optical element was denoted as 100, the use of molding materials (glass preforms) having weights falling within the range of 110 to 155 permitted the efficient manufacturing of biconvex lenses of stable quality.

### Embodiment 2

Manufacturing Concave Meniscus Lenses

A concave meniscus shape was adopted as the final shape of a lens obtained by post processing for centering and edging a press-molded article. The concave meniscus lens comprised of glass A in Table 3 was press molded by the following procedure.

First, the lens was designed by a known lens design procedure based on the optical constants of the glass material. Next, the volume of the biconvex meniscus lens was calculated with lens design software, and from the specific gravity of the glass material employed, the weight of the glass corresponding to that volume, that is, the weight of the concave meniscus lens to be obtained, was calculated as 150 mg.

Next, denoting the calculated weight of the concave meniscus lens as 100, multiple (seven types) of sphere shaped glass preforms for obtaining this concave meniscus lens were formed by hot forming with weights of 172, 180, 200, 218, 235, 244, and 260, respectively.

Next, while in a heat-softened state, each of the glass preforms was pressed at a prescribed load in a mold for molding concave meniscus lenses to form a press-molded article. As shown in FIG. 3, the approximate shape of the press-molded article had a center portion (of lens outer diameter D) that would become the final product, and moving outward, a lens-shaped extension 21, a junction portion 24, a flat portion 22, and an outer peripheral portion 23. The weights of each of these portions varied. With the exception of the weights of the glass preforms, the molding conditions were identical.

Next, each of the press-molded articles was annealed at a temperature not exceeding the glass transition temperature Tg thereof to relieve internal irregularity and adjust the refractive index of the press-molded articles.

Each of the press-molded articles was then post processing for centering and edging. Not more than 65 seconds per lens was allowed for post processing for centering and edging. Concave meniscus lenses of essentially identical shape were prepared and the seven concave meniscus lenses thus obtained were evaluated for external appearance, performance, and time required for centering and edging. The evaluation results are given in Table 2.

TABLE 2

| | Weight ratio | | | | | | |
|---|---|---|---|---|---|---|---|
| Evaluation | 172 | 180 | 200 | 218 | 235 | 244 | 260 |
| External appearance | B | A | A | A | A | A | A |
| Performance | B | A | A | A | A | A | B |
| Time required for | A | A | A | A | A | B | B |
| post processing for | | | | | | | |
| centering and edging | | | | | | | |

In Table 2, lenses with a defect rate of less than 10% are denoted by “A” and those of 10% or more by “B” for external appearance and performance inspection. Lenses falling within the permitted range obtained by conversion of manufacturing cost are denoted by “A” and those exceeding the permitted range by “B” for the time required for centering and edging.

As will be seen from Table 2, the concave meniscus lens obtained from the preform with a weight ratio of 172 achieved external appearance and performance evaluations of “B”.

Concave meniscus lenses obtained from preforms having a weight ratio of 180 to 240, with defect rates of less than 10%, did not present a problem in any of the evaluation categories. However, the concave meniscus lens obtained from the preform with a weight ratio of 244 exceeded the permitted range in the category of time required for centering and edging. Further, the concave meniscus lens obtained from the preform with a weight ratio of 260 had a surface defect rate exceeding 10% due to astigmatism and eccentricity defects caused by slight eccentrically located materials. Thus, the performance and centering and edging time evaluations were “B”.

Based on the above inspection, when the weight of the final optical element was denoted as 100, the use of molding materials (glass preforms) having weights falling within the range of 180 to 240 permitted the efficient manufacturing of concave meniscus lenses of stable quality.

### Embodiment 3

Determining Lens Shape

The data on permitted lens weight ranges shown in FIG. 3 were prepared for various materials based on the knowledge that desired lenses having good external shape and optical properties and requiring relatively little post processing for centering and edging time can be obtained with high efficiency by employing glass preforms with a weight falling within a range of 110 to 155% of the weight of the final product when manufacturing final lenses having a biconvex or convex meniscus shape and by employing glass preforms with a weight falling within a range of 180 to 240% of the weight of the final product when manufacturing final lenses having a biconcave or concave meniscus shape.

TABLE 3
(unit: mg)

| Molding | | | | Lens |
|---|---|---|---|---|
| material (nd)/ | | Preform | | weight |
| (specific gravity) | PF shape | weight | Lens shape | range |
| Borate glass A | Sphere | 50-1000 | convex lens | 32-909 |
| (1.69)/(3.5) | | | concave lens | 21-560 |
| | biconvex | 100-8000 | convex lens | 65-7270 |
| | curved | | concave lens | 42-4450 |
| | surface | | | |
| Borate glass B | Sphere | 100-1000 | convex lens | 65-909 |
| (1.81)/(4.6) | | | concave lens | 42-560 |
| | biconvex | 100-7000 | convex lens | 65-6360 |
| | curved | | concave lens | 42-3890 |
| | surface | | | |
| Borosilicate glass C | Sphere | 10-1000 | convex lens | 6.5-909 |
| (1.59)/(2.8) | | | concave lens | 4.2-560 |
| | biconvex | 50-10000 | convex lens | 32-9090 |
| | curved | | concave lens | 20-5560 |
| | surface | | | |
| Borosilicate glass D | Sphere | 50-1000 | convex lens | 32-909 |
| (1.58)/(3.0) | | | concave lens | 20-560 |
| | biconvex | 100-8000 | convex lens | 65-7270 |
| | curved | | concave lens | 42-4450 |
| | surface | | | |
| Phosphate glass E | Sphere | 100-1000 | convex lens | 65-909 |
| (1.69)/(3.3) | | | concave lens | 42-560 |
| | biconvex | 150-8000 | convex lens | 97-7270 |
| | curved | | concave lens | 62-4450 |
| | surface | | | |
| Phosphate glass F | Sphere | 100-500 | convex lens | 65-455 |
| (1.82)/(3.6) | | | concave lens | 42-280 |
| | biconvex | 200-4000 | convex lens | 129-3640 |
| | curved | | concave lens | 83-2220 |
| | surface | | | |

Glass B comprises Nb, W and Zr.
Glasses E and F comprise Ti, Nb and W.

In Table 3, the item of preform weight gives the upper and lower limits for molding when hot forming a preform (PF shape) that is sphere shaped or has a biconvex curved surface using various molding materials. Molding of relatively small sphere preforms is possible, while molding of relatively large preforms having biconvex curved surface shapes is possible.

The item of lens weight range gives suitable weight ranges over which lenses of good quality and low manufacturing cost can be obtained based on the above-stated knowledge when molding convex or concave lenses from various preforms arranged by material and shape.

For example, when glass A is selected as molding material based on the optical characteristics of the lens to be obtained and small convex lenses are manufactured from molding material A, the range over which spherical preforms suited to small lenses can be molded is 50 to 1,000 mg. The weight range of the convex lens finally obtained by press molding this spherical preform while in a heat-softened state and centering and edging the press molded product is 32 to 909 mg based on Table 3. Thus, by designing a lens within this weight range, a determination can be made without design trial and error.

As described in Embodiment 1, when the weight of a biconvex lens (or convex meniscus lens) is denoted as 100, optimal preform weights fall within a range of 110 to 155%. When the preform weight is from 50 to 1,000 mg, the lens weight can be calculated as from 100/155 to 100/110 of the preform weight, that is, as running from a minimum value of 32 to a maximum value of 909 mg, within which range lenses having desired properties can be obtained.

As a further example, when glass D is selected as molding material based on the optical characteristics of the lens to be obtained and relatively large-diameter concave meniscus lenses are manufactured from this material, the range over which preforms having a biconvex curved surface shape can be molded is 100 to 8,000 mg. The weight range of the concave lens finally obtained by press molding this preform while in a heat-softened state and post processing for centering and edging the press molded product is 42 to 4,450 mg based on Table 3. Thus, by designing a lens within this weight range, a determination can be made without design trial and error.

As described in Embodiment 2, when the weight of a concave meniscus lens (or biconcave lens) is denoted as 100, optimal preform weights fall within a range of 180 to 240%. When the preform weight is from 100 to 8,000 mg, the lens weight can be calculated as from 100/240 to 100/180 of the preform weight, that is, as running from a minimum value of 42 mg to a maximum value of 4,450 mg, within which range lenses having desired properties can be obtained.

The manufacturing method of the present invention can be used to manufacture both spherical and aspherical lenses. The lenses obtained by the manufacturing method of the present invention can be suitably employed as the biconvex lenses, convex meniscus lenses, and concave meniscus lenses employed in image pickup optical devices such as cameras (including digital and VTR cameras).

The present disclosure relates to the subject matter contained in Japanese Patent Application No. 2003-300064 filed on Aug. 25, 2003, which is expressly incorporated herein by reference in its entirety.

1. A method of manufacturing an optical element of prescribed shape, comprising the steps of;
press molding a preformed molding material in a heat-softened state to obtain a press-molded product, and
subjecting the press-molded product to a post processing for centering and edging, said preformed molding material having a weight within a range of 110 to 155% of a weight of the optical element when the optical element has a biconvex or convex meniscus shape, and said preformed material having a weight within range of 180 to 240% of a weight of the optical element when the optical element has a biconcave or concave meniscus shape.

2. The method of claim 1 wherein the preformed molding material is obtained by dropping or flowing glass melt from a nozzle and cooling.

3. The method of claim 1 wherein the preformed molding material has a refractive index n_{d} of at least 1.7.

4. The method of claim 1 wherein the preformed molding material comprises a phosphate glass.

5. The method of claim 1 wherein the preformed molding material has a weight in a range of from 10 to 8,000 mg.

6. The method of claim 1 wherein the preformed molding material is substantially in a shape of sphere and has a weight in a range of from 10 to 1,000 mg.

7. The method of claim 1 wherein the preformed molding material has a biconvex curved surface shape and a weight in a range of from 150 to 8,000 mg.

8. A method of manufacturing an optical element comprising the steps of;
preparing a preformed molding material by dropping or flowing glass melt from a nozzle and cooling,
press molding the preformed molding material in a heat-softened state to obtain a press-molded product, and
subjecting the press-molded product to a post processing for centering and edging to obtain an optical element of biconvex shape or convex meniscus shape,
wherein the shape of the optical element is determined by a process comprising
(1) determining a type of glass based on optical properties of the optical element,
(2) determining a weight range or volume range of the molding material capable of being preformed based on the type of the glass, and
(3) determining the shape of the optical element so that a weight or volume of the optical element falls within a range of from 100/110 to 100/155 of the a weight or volume within said weight range or volume range of the molding material.

9. A method of manufacturing an optical element comprising the steps of;
preparing a preformed molding material by dropping or flowing glass melt from a nozzle and cooling,
press molding the preformed molding material in a heat-softened state to obtain a press-molded product, and
subjecting the press-molded product to a post processing for centering and edging to obtain an optical element of biconcave shape or concave meniscus shape,
wherein the shape of the optical element is determined by a process comprising
(1) determining a type of glass based on optical properties of the optical element,
(2) determining a weight range or volume range of the molding material capable of being preformed based on the type of the glass, and
(3) determining the shape of the optical element so that a weight or volume of the optical element falls within a range of from 100/180 to 100/240 of a weight or volume within said weight range or volume range of the molding material.
